(19) United States
(12) Patent Application Publication
(10) Pub. No.: US 2026/0234755 A1
(43) Pub. Date: Aug. 13, 2026

(54) TERNARY Ti-Zr-Hf ALLOY

(71) Applicant: ROLEX SA, Genève 26 (CH)

(72) Inventor: Armand GIRARD-NOYER, Nyon (CH)

(21) Appl. No.: 19/157,567

(22) PCT Filed: Apr. 25, 2024
(86) PCT No.: PCT/EP2024/061358

§ 371 Date: Aug. 18, 2025

(30) Foreign Application Priority Data
May 4, 2023 (EP) 23171553.3

(51) Int. Cl. C22C 14/00; C22C 1/02; C22C 16/00; C22F 1/18; C23C 8/12

(52) U.S. Cl. CPC C22C 14/00; C22C 1/02; C22C 16/00; C22F 1/183; C22F 1/186; C23C 8/12

(57) ABSTRACT

Disclosed is a ternary Ti—Zr—Hf alloy comprising 18.4 at. % to 80 at. % zirconium and 2 at % to 40 at. % hafnium, the balance being titanium along with unavoidable impurities in an amount of up to 0.3 at. % of the final composition, and an article made therefrom, optionally an article having a dark adherent oxide layer such as a watch exterior component or a watch movement component. Further disclosed are a process for obtaining the article made of a ternary Ti—Zr—Hf alloy having a dark oxide layer, the process comprising a thermal treatment in oxygen-containing atmosphere, a use of the ternary alloy as a material for watch components, and a watch component obtainable by the process of the invention.

The present invention concerns a ternary Ti—Zr—Hf alloy, an article made thereof, optionally comprising a dark oxide layer, and a process for obtaining said article, which preferably is a watch exterior component or a watch movement component.

### PRIOR ART

### Binary Ti—Zr Alloys

GB 1 305 879 concerns a Ti-(25-75%) Zr alloy for surgical and dental applications. The % in this reference are wt. %. The alloy may contain at most 2 wt. % of other elements, which apparently are unavoidable impurities. Fe, O₂ and N₂ are specifically disclosed as impurities or rigidity-increasing additions which are contained in commercial grade of pure titanium. The machining fashioning of the Ti—Zr alloy remains comparable to titanium. Surface treatments may be carried out, whereby oxides, nitrides or carbides are produced by heat treatment (gas, salt etc.) or by anodic oxidation.

WO 99/04055 A1 discloses a surface hardening treatment of pure titanium, pure zirconium or a titanium-zirconium alloy. The hardening is achieved by a two-step heat treatment, i.e. oxidation in air or oxidizing atmosphere (O₂ and N₂) at 700-1000° C. for a short time of 0.1 to 1 h, followed by a heat treatment in vacuum or inert/neutral atmosphere at 700-1000° C. for 10 to 50 h to allow oxygen diffusion. The titanium alloys disclosed are Ti6Al4V, Timet551 (i.e. Ti-4Al-4Mo-4Sn-0.5Si) and Timet 10-2-3 (i.e. Ti-10V-2Fe-3Al).

US 2012/0216921 A1 (corresponding to U.S. Pat. No. 9,382,606 B2), US 2009/0199932 A1 (corresponding to U.S. Pat. No. 8,262,814 B2), US 2012/0219736 A1 (corresponding to U.S. Pat. No. 9,303,306 B2) and US 2012/0291929 A1 (corresponding to U.S. Pat. No. 9,382,607 B2), all of Gad Zak (in the following designated as “Zak patents”) disclose the oxidation treatment by heat treatment in air (or oxygen-enriched atmosphere) of a binary Ti—Zr alloy consisting of about 18.4% to about 65.6% zirconium by atomic weight and titanium, or between about 30.9% and about 65.6% zirconium by atomic weight and titanium. A ratio of 34.4% zirconium to 65.6% titanium by atomic weight corresponds to 50% by weight titanium and the balance zirconium, or art-recognized levels of impurities, based on the atomic weights for Ti of 47.867 and for Zr of 91.224. The oxidation treatment can be performed in one step or in two steps (a quenching step, e.g. by water quenching, can additionally be conducted between two heat treatments).

The four patents concern binary TiZr alloys, having 18.4 to 65.6 at % Zr, with a first heat treatment at a temperature of 250 to 880° C. and a duration of 10 to 110 minutes. The second heat treatment can be conducted between 480 to 880° C. for about 100 minutes. The different scopes of the patents concern specific characteristics resulting from the process (color obtained such as black or grey or surface properties such as polished, satin or matte finish, or specific process sub-steps, . . . ). The obtained alloys have a dark (i.e. black or grey) surface and can be used for numerous purposes, inter alia watches and watch bracelets.

### Ternary Ti—Zr—X Alloys

WO 96/23908 A1 discloses a process for surface hardening of a Ti—Zr—X alloy by creating an oxide layer by heating to 200° C. to 1200° C., most preferably to 500° C. The time for heating depends on the temperature used. At 500° C., the time is 6 hrs. Heating is performed in air or oxygen-enriched atmosphere. The documents concern more particularly the ternary alloys Ti—Zr—Nb, of preferential composition Ti, 10-20 wt. % Nb and 0.5 to 20 wt. % Zr, or Ti, 35 to 50 wt. % Nb, and 0.5 to 20 wt. % Zr. The most preferred Ti-13Nb-13Zr alloy is the subject of a patent by the same applicant (U.S. Pat. No. 5,169,597). U.S. Pat. No. 5,372,660/WO and 96/23908 A1 disclose that the most commonly used Ti alloy, Ti-6Al-4V is not affected by the process of forming a hard oxide layer, which is ascribed to the absence of Zr.

U.S. Pat. No. 5,820,707 discloses a two-step high temperature (T>1000° C.) air oxidation treatment of ternary alloys to obtain a hard surface described as blue/black. The claims cover a material formed of complete or near complete mixed oxides with a Young's modulus of less than 35 GPa. The claimed alloys are ternary alloys of the Ti(Zr, Hf)(Nb, Ta,V) type. There is therefore necessarily a third element such as Nb (possibly combined with Ta and/or V). The concentration ranges mentioned are, for a Ti—X—Y alloy with X and Y in atomic %, X=Zr, Hf or a mixture with 10<X<30 and Y=Nb, Ta, V or a mixture with 5<Y<10. The document discloses that many of the alloys of titanium with zirconium or hafnium are characterized by their extraordinarily rapid oxidation in air at only modestly elevated temperatures, which has severely limited the usefulness of such alloys for many applications.

U.S. Pat. No. 10,975,462 B2 discloses a Ti—Zr—O alloy (in mass %: 83≤Ti≤95.15, 4.5≤Zr≤15 and 0.35≤O≤2) whose oxygen addition, which is considered as a full alloying element, allows it to match or even surpass the mechanical properties of grade 5 ELI (extra low interstitials) titanium while being biocompatible and having excellent ductility. No surface treatment of the alloy is mentioned. The oxygen is included in the alloy by use of TiO₂ and/or ZrO₂ powder in controlled amounts during the melting of the alloy.

Y. Yamabe-Mitarai et al. Journal of Alloys and Compounds, vol. 911, 6 Apr. 2022, XP087053515, ISSN 0925-8388, DOI: 10.1016/J.ALLCOM.2022.164849 reports on phase stability of Ti-containing high-entropy alloys with a bcc or hcp structure which are for example used in aircraft jet engines. The document discloses a ternary Ti—Zr—Hf alloy with the nominal composition Ti₃₄Zr₃₃Hf₃₃ and comprising 35.7 at. % Ti, 29.2 at. % Zr and 35.1 at. % Hf as analyzed by EDS.

J. Blacktop et al., Journal of the Less-Common Metals, vol. 109, no. 2, 15 Jul. 1985, pages 375-380, XP024072756, ISSN: 0022-5088, DOI: 10.1016/0022-5088 (85) 90070-0 describes measurements of the temperature and enthalpy changes of the hcp to bcc transformation in several Ti—Zr—Hf alloys. The document discloses a ternary Ti—Zr—Hf alloy comprising 37.5 at. % Ti, 37.5 at. % Zr and 25 at. % Hf.

### Description of the Technical Problem

The inventors aimed, on one hand, at developing a variable density alloy, not magnetizable and having good mechanical properties, allowing to realize a dark and hard layer on the surface, in order to propose a durable dark exterior. In particular, the inventors desired to develop an alloy having a dark layer on the surface.

None of the alloys discussed above had the desired properties. The problem of the invention, consequently, is to develop an alloy fulfilling the above-mentioned requirements. Therefore, the inventors developed the ternary Ti—Zr—Hf alloys of the invention which solved this problem.

The problem has been solved by the ternary Ti—Zr—Hf alloy of claim 1. Preferred embodiments, such as an article made of the alloy, optionally having a dark oxide layer on one or more surfaces thereof, in particular watch parts and/or watch movement parts, as well as a process for manufacturing them and a use of the alloy are specified in the claims as well.

In particular, the following embodiments are provided by the invention:

A ternary Ti—Zr—Hf alloy comprising 18.4 at. % to 80 at. % zirconium and 2 at % to 40 at. % hafnium, the balance being titanium. The alloy of the invention may contain, besides Ti, Hf and Zr, accidental impurities as described below.

Preferably, in the ternary Ti—Zr—Hf alloy of the invention, the amount of Zr is 78 at. % or less, more preferably 75 at % or less, more preferably 60 at. % or less, even more preferably 50 at. % or less, and most preferably 30 at. % or less. The amount of Zr is preferably 20 at. % or more, more preferably 23 at. % or more, most preferably 25 at % or more. Even more preferably, in the ternary Ti—Zr—Hf alloy of the invention the amount of Zr is 20-78 at. %, more preferably 23-75 at %, even more preferably 23-50 at. %, most preferably 25-30 at. % Zr.

In the ternary Ti—Zr—Hf alloy according to the invention, the amount of Hf preferably is 35 at. % or less, more preferably 30 at. % or less, even more preferably 25 at. % or less, more preferably 20 at. % or less, even more preferably 10 at. % or less, most preferably 7 at. % or less. Preferably, the amount of Hf is 2 at. % or more, more preferably 3 at. % or more. Preferably, the amount of Hf is 2-20 at % Hf, more preferably 2 to 10 at. %, more preferably 3-7 at. % Hf.

In the ternary Ti—Zr—Hf alloy according to the invention, the density of the alloy is between 5 and 8 g/cm³ which can be adjusted as desired by appropriately selecting the amounts of Zr and Hf in the ternary alloy.

The ternary alloy of the invention is paramagnetic.

The invention provides an article made of the ternary Ti—Zr—Hf alloy described above. In particular, the article additionally has a dark oxide layer on one or more surfaces. For example, the article of the invention is a watch exterior component or watch movement component.

The thickness of the dark oxide layer is 5 to 25 μm, preferably 7 to 20 μm, more preferably about 15 μm.

The hardness of the dark oxide layer, measured by nano-indentation according to ISO 14577-1, 1^{st} ed. 2002, Metallic materials—Instrumented indentation test for hardness and materials parameters—Part 1: Test method, is at least 10 GPa H_{IT}, more preferably even higher than 14 GPa H_{IT}.

Optionally, the surface of the dark oxide layer is polished partially or completely. Polishing can be achieved by usual techniques. Alternatively, the surface can be partially or completely finished by other commonly used finishing techniques such as sandblasting, brushing, or satin finishing.

The invention further provides a process for obtaining the article made of the ternary Ti—Zr—Hf alloy comprising the dark oxide layer described above, the process comprising the following steps:
1) manufacturing the alloy comprising the desired amounts of Ti, Zr and Hf and accidental impurities by an usual melting process which may comprise several melting and cooling steps,
2) forming the alloy to the desired shape of the article,
3) optionally grinding, fine machining, sandblasting, brushing and/or polishing one or more surfaces of the article,
4) oxidizing the surface(s) of the article by carrying out a heat treatment in an oxygen-containing atmosphere at a temperature of 400 to 650° C. for an appropriate time, and
5) optionally sandblasting, brushing, satin finishing or polishing the oxidized surface(s).

The temperature range of the thermal treatment is chosen regarding the nature of the hardening process by oxide layer conversion, in order to optimize the process parameter, for example the duration of the process. The lower temperature limit is determined by the oxidation reaction that would slow down to an unacceptable level due to the lack of reactivity. The higher temperature limit is determined by the slower oxygen diffusion in the β-phase and by the risk of oxide layer delamination at β→α phase transition upon cooling. β-transus of an alloy can be determined before carrying out the thermal treatment by, for example, DSC (Differential Scanning calorimetry). It is, further, preferable to find an optimum for using the highest possible temperature to speed up the conversion hardening and the lowest possible temperature to reduce the cost of heating equipment, its operation and the thermal deformation of parts to be treated.

In one embodiment, the oxidizing heat treatment is carried out at 400 to 650° C. Preferably, the oxidizing heat treatment of the article is carried out for 1 to 420 min, preferably 60 to 400 min, more preferably 100 to 400 min, most preferably 180 to 360 min. In another embodiment, the oxidizing heat treatment of the article is carried out for less than 60 min, preferably less than 30 min. The oxygen-containing atmosphere is air, pure oxygen gas or an oxygen containing environment such as a gas mixture of oxygen and an inert gas such as argon. Most preferably, the oxidizing heat treatment is carried out by thermal heating in an oven.

The invention provides the use of the ternary Ti—Zr—Hf alloy described above as a material for watch exterior components and/or watch movement components.

A watch exterior component or watch movement component made of the ternary Ti—Zr—Hf alloy of the invention has a dark surface layer as described above, or is obtainable by the oxidizing heat treatment process of the invention disclosed above. The watch exterior component or watch movement component of the invention is obtainable by the process of the invention.

### DETAILED DESCRIPTION OF THE INVENTION

The Ti—Zr—Hf alloy family of the invention has been developed by the inventors in order to have a material capable of forming a hard, thick, adherent and dark layer on the surface of a watch component. Such alloys are interesting for applications within the movement (for example, bridge axes) as well as for the case, bracelet, and also for bracelet pins. This family of alloys also allows the density to be adjusted, notably in a range between 5 and 8 g/cm³, potentially giving more freedom in the conception and design of watch components.

Ternary Ti—Zr—Hf alloys of the invention are particularly interesting in this respect due to the ease of alloying, the possibility of manufacturing watch parts, their finishing and the formation of an oxide layer. The oxide layer formed by conversion during heat treatment is adherent, thick, hard and dark. It appears surprisingly that Ti, Zr and Hf form a perfect solid solution for both high temperature β-phase and low temperature α-phase, which favorizes alloying, and allowed the inventors to produce watch components for watch exterior with a satisfactory finish.

Preferable amounts of the alloying components Ti, Zr and Hf are defined in the appended claims.

Particular examples of alloys of the invention are as follows:

A ternary Ti—Zr—Hf alloy, comprising
18.4 at. % Zr and 35 at. % Hf, or
20 at. % Zr and 35 at. % Hf, or
30 at. % Zr and 2.5 at % Hf, or
23 at % Zr and 2.5 at % Hf, or
23 at % Zr and 7 at % Hf, or
30 at % Zr and 10 at % Hf, or
50 at. % Zr and 10 at. % Hf, or
60 at. % Zr and 20 at. % Hf, or
75 at. % Zr and 10 at. % Hf,
the balance in each case being titanium, along with unavoidable impurities.

The alloy of the invention preferably consists of Ti, Zr and Hf. Unavoidable impurities, however, may amount to up to about 0.3 at. % of the final composition. The impurities mainly result from the manufacture of the starting alloying metals and are, e.g. Fe, N, O, C and/or H.

In the present invention, amounts of metals in alloys are given as at. %. The total of all alloying elements is 100 at. %. The alloys can be represented by the following abbreviation: Ti-yZr-zHf, which means y at. % Zr, z at. % Hf, the balance being Ti if not indicated otherwise, the total being 100 at. %. The parameters y and z are selected according to the amounts of Zr and Hf defined in the claims.

The pure elements are weighed to ensure the correct relative atomic composition of the resultant alloy. Alternatively, the composition of the alloy can be determined in the alloy by usual metal analysis methods known in the art. X-ray fluorescence (EDXRF-Energy Dispersive X-ray fluorescence, WDXRF—Wavelength Dispersive X-ray fluorescence), and Optical Emission Spectroscopy (spark-OES, ICP-OES/MS—Inductively-Coupled Plasma OES/Mass Spectroscopy, LIBS—Laser Induced Breakdown Spectroscopy, SEM/EDX and SEM/WDX—Scanning Electron Microscopy coupled to Energy Dispersive or Wavelength Dispersive X-ray spectroscopy) are methods routinely used.

In the present specification, the terminology “Ti based alloy”, “Zr based alloy” or “Hf based alloy” is used interchangeably, as well as the notations “Hf—Zr—Ti”, “Zr—Hf—Ti” or “Ti—Zr—Hf”, since the microstructure and properties are comparable.

The density of the ternary alloy of the invention is determined by using a Buoyancy method. It is preferably 5 to 8 g/cm³. The density can be adjusted by appropriately selecting the amounts of Ti, Zr and Hf. The density of stainless steel is about 8 g/cm³. Therefore, the alloys of the invention preferably have a lower density than stainless steel, e.g. the families of austenitic 904L or 316L steels, which is normally used for watch components, and allows to manufacture light-weight watch components and watches.

The ternary alloy of the invention is obtained by known melting processes of the metal components of the starting alloy as described below. The process may comprise several steps of melting and cooling.

The article of the invention is made from the above-described ternary alloy by routine processes such as cold or hot forming, cutting, milling, casting, drawing or any other suitable method. The article of the invention preferably is a watch component, in particular a watch exterior component or a watch movement component. Examples of watch exterior components are watch cases, watch wristbands and/or parts thereof (such as links, pins, clasps, attachments), crowns, bezels, hands, or any other watch exterior parts. Examples of watch movement components are balance wheels, barrels, bridges, base plates, shafts, pinions or any other watch movement part.

The article of the invention is paramagnetic and is thus unable to be magnetized by magnetic fields.

The article of the invention preferably presents a dark oxide layer on one or more surfaces thereof, preferably on all surfaces. The dark oxide layer can be obtained by the process of the invention disclosed below, which comprises a thermal oxidation treatment as an essential step.

Usually, after forming the dark oxide layer on the article, all surfaces thereof are covered by the oxide layer. However, if desired, the dark oxide layer can be removed from one or more of the surfaces of the article, e.g. by abrasive treatments, machining, laser treatment or the like. The resulting article consequently has only one or several, but not all of its surfaces, covered by the dark oxide layer.

The thickness of the dark oxide layer is preferably 5 to 25 μm, more preferably 7 to 20 μm, most preferably about 15 μm. The thickness of the dark oxide layer is determined on a metallographic cross-section of the article by Scanning Electron Microscopy or by optical microscopy. An example of such a section is shown in FIG. 4. The high layer thickness of up to 25 μm allows for final surface finishing treatments such as sandblasting, satin-finishing, brushing and/or polishing that would not be possible with a lower layer thickness.

The color of the article having the dark oxide layer is black or dark grey. There are no or only very slight bluish tones in said dark color. The color of the article of the invention in CIELab color space L*a*b (determined according to EN ISO 11664-4 “Colorimetry-Part 4: CIE 1976 L* a* b* Colour space”, ed. 2019), is preferably L*<50, |a*|<5, |b*|<5, more preferably L*<40, |a*|<1, |b*|<1. In the CIELab color system, L* denotes the perceptual lightness and a* and b* denote the unique colors of human vision: red, green, blue and yellow. L* defines black as 0 and white as 100. The a* axis relates to the red-green opponent colors, with negative values toward green and positive values toward red. The b* axis represents blue-yellow opponent colors, with negative numbers toward blue and positive numbers toward yellow.

The hardness of the oxide layer measured by nano-indentation according to ISO 14577-1, 1^{st} ed. 2002, Metallic materials—Instrumented indentation test for hardness and materials parameters—Part 1: Test method, is at least 10 GPa H_{IT}, preferably is at least 14 GPa H_{IT} to 14 GPa H_{IT}, more preferably higher than 14 GPa H_{IT}. That is, the surface of the article is very hard and thus resistant to scratches and has improved overall mechanical resistance. It should be noted that the standard hardness measurement of the oxide layer by indentation, for example Vickers hardness according to the above-cited ISO 6507, 2^{nd} ed. 1997, is quite difficult because of the very low optical contrast of the indentation mark on the dark oxide surface. To overcome this issue, nano-indentation according to the above-cited ISO 14577-1, 1^{st} ed. 2002, can be used in the present invention to measure the hardness of the oxide layer, as this technique does not require optical microscopy to analyse the shape and measure the dimensions of an indentation mark.

One should distinguish the hardness of a bulk alloy material from the hardness of the conversion oxide layer on the surface. The conversion oxide layer is much harder than the bulk, unoxidized alloy.

The notion of conversion comes from the gradual formation of the oxide layer from the surface inwards. There is a gradient of oxygen concentration between the oxide layer and the bulk material, where the oxygen concentration goes to almost zero and the hardness goes from that of the oxide layer to the hardness of the bulk alloy. This gradient is typically measurable by GDOES (Glow Discharge Optical Emission Spectroscopy) and can take place within usually 100-1000 nm and, due to this relatively narrow region, is not always resolved (lack of contrast or resolution power) in a metallographic section with optical or electron microscopies.

The dark surface oxide layer shows a very strong adhesion to the alloy core, i.e. it does not peel off. According to peel-off test ISO 2409, 4th ed. 2013, with the cutting tool of 1a type, the test result is evaluated as 1 on the scale of from 0 to 5. It has a dense surface with practically no pinholes or surface defects. This is determined by the oxide formation process, when the oxide layer grows inward between the initial thin natural oxide layer of a few nm thickness and the bulk metal alloy, allowing uniform grow of the oxide at the oxide-metal interface as illustrated on the right side in FIG. 1 (02-migration mechanism).

The invention provides a process for obtaining said article having a dark oxide layer.

In the first step, the alloy having the desired composition is formed by usual melting processes.

The amounts of starting metals are selected and weighed according to the desired composition of the alloy.

Optionally, the starting materials, e.g. metal chips or slugs of the respective alloying metals, are cleaned before melting, e.g. by ultrasonic cleaning.

The elements are then melted in an inert atmosphere or vacuum using any alloy ingot manufacturing method based on melting and solidification, such as vacuum induction melting (VIM) or vacuum arc melting (VAR). Typically, the method includes several melting and cooling steps to produce the alloy ingot, which ensures homogeneity, before allowing it to solidify and cool-down to room temperature inside the inert chamber.

Then, in an optional step, the alloy is annealed and quenched in order to adjust the mechanical properties of the material.

The obtained alloy is formed to the desired article shape by usual processes known in the art, such as hot and/or cold forming, cutting, milling, casting or the like.

One or more surfaces of the thus obtained article can optionally be subjected to surface treatment such as grinding, fine machining, sandblasting and/or polishing, as desired.

Then, in a next step the surfaces of the article are oxidized in order to obtain the desired dark surface layer. The surface oxidation can, in one embodiment, be carried out by heat treatment in an oxygen-containing atmosphere at a temperature of 400 to 650° C., preferably 400 to 550° C., for an appropriate time, preferably for 1 to 420 min, more preferably for 60 to 400 min, even more preferably 100 to 400 min, most preferably 180 to 360 min. In another embodiment, the oxidizing heat treatment of the article can be carried out for less than 60 min, more preferably less than 30 min. The temperature is kept lower than the transition temperature from the xx phase to the β-phase.

The oxidizing heat treatment is preferably carried out in an oven by thermal heating, preferably an electric heated oven.

Alternatively, it is possible to use plasma-electrolytic oxidation as oxidation treatment.

The oxygen-containing atmosphere can be air, pure oxygen gas or an oxygen-containing environment such as a mixture of oxygen and an inert gas, e.g. argon.

If desired, the surfaces of the surface-oxidized article obtained as described above can be subjected to common finishing treatments such as sandblasting, brushing, satin finishing or polishing.

The invention provides a use of the ternary alloy of the invention as a material for watch exterior components and/or watch movement components as described above. Preferably and usually, the alloy is shaped to obtain the watch part, and then surface-oxidized as disclosed above.

Finally, the invention provides watch components having a dark surface layer. Applications of the alloys of the invention, beyond watch exterior components, are mobile components of watches such as wristband pins and movement pins such as balance shafts or pinions. The hard oxide layer allows for good wear resistance. Furthermore, the component is paramagnetic, which is important for watches.

### DESCRIPTION OF THE FIGURES

FIG. 1 shows two different oxidation mechanisms of Ti—Zr alloys for different Zr contents.

FIG. 2 shows bulk hardness values (HV1 hardness) of different Ti—Zr—Hf alloys as function of Zr+Hf concentration with respect to Ti concentration. The zero on the abscissa axis correspond to Zr+Hf alloy without Ti. The +100 on the abscissa axis correspond to 100 at % Ti. The dotted line is a second order polynomial fit to the data and is to guide the eye.

FIG. 3 shows photographs of two Ti-23Zr-7Hf samples, on the left side A before oxidation (polished); on the right side, B oxidized in air at 550° C. for 5 h, then polished.

FIG. 4 is a Scanning Electron Microscope micrograph of a metallographic section, showing the conversion layer on a Ti-23Zr-7Hf sample oxidized in air at 550° C. for 5 h.

FIG. 5 (outside of the scope of the invention) shows the Ti—Zr—Hf ternary diagram corresponding to the chemical compositions explored by the inventors showing the minimum Zr content to form a hard oxide layer. The grey area corresponds to the exclusion zone, where the Zr content is known, from the dedicated experiments of the inventors described in this specification, to be too low to obtain an adherent oxide layer (Zr<18.4 at. %). The diagonal lines with numbers are isolines showing constant Ti concentration in % at expressed by those numbers.

FIG. 6 (in the scope of invention) shows the Ti—Zr—Hf ternary diagram corresponding to the chemical compositions explored by the inventors showing the intermediate Zr content to form a hard oxide layer. The grey area corresponds to the exclusion zone, where the Zr content is known, from the dedicated experiments of the inventors described in this specification, to be too low to obtain an adherent oxide layer (Zr<18.4 at. %). The labels outside the grey zone mark the compositions with sufficient Zr content and form a dark, hard and adherent oxide layer. The diagonal lines with numbers are isolines showing constant Ti concentration in % at expressed by those numbers. The binary alloys shown (Ti-45Zr and Ti-30Zr) are outside of the scope of the invention.

FIG. 7 shows the Ti—Zr—Hf ternary diagram corresponding to the chemical compositions explored by the inventors showing the maximum Zr content to form a hard oxide layer. The grey area corresponds to the exclusion zone, where the Zr content is known, from the dedicated experiments of the inventors described in this specification, to be too low to obtain an adherent oxide layer (Zr<18.4 at. %). The labels outside the grey zone mark the compositions with sufficient Zr content and form a dark, hard and adherent oxide layer. The diagonal lines with numbers are isolines showing constant Ti concentration in % at expressed by those numbers. The binary alloys shown (80Zr-20Hf and 90Zr-10Hf) and pure Zr are outside of the scope of the invention.

FIG. 8 shows a metallographic section of the Ti-30Zr-2.5Hf alloy sample oxidized in air at 600° C. for 1 minute followed by slow cooling to room temperature obtained in Example 1.

### CRYSTAL STRUCTURE, PROPERTIES

For a good adhesion of an oxide layer to a metal or metal alloy surface, it is preferable to avoid oxidation at temperatures when a phase transition with crystal structure modification can take place, leading to unwanted stress on the oxide layer with increased risk of its peeling off. All three alloying elements, Ti, Zr and Hf, have a known phase transition at some point above 800° C. from an α phase with a hexagonal close-packed (hcp) structure to a body-centered cubic (bcc) structure known as β phase.

The inventors discovered experimentally that Ti, Zr and Hf form a ternary alloy with perfect solution in a wide concentration range of alloying elements. The supposed α→β transition was determined at around 691±5° C. by DSC technique for 67.5Ti-30Zr-2.5Hf alloy.

To the best knowledge of inventors, this is the first experimental realization of Ti—Zr—Hf in a wide concentration of alloying metals.

### Oxidation Mechanism

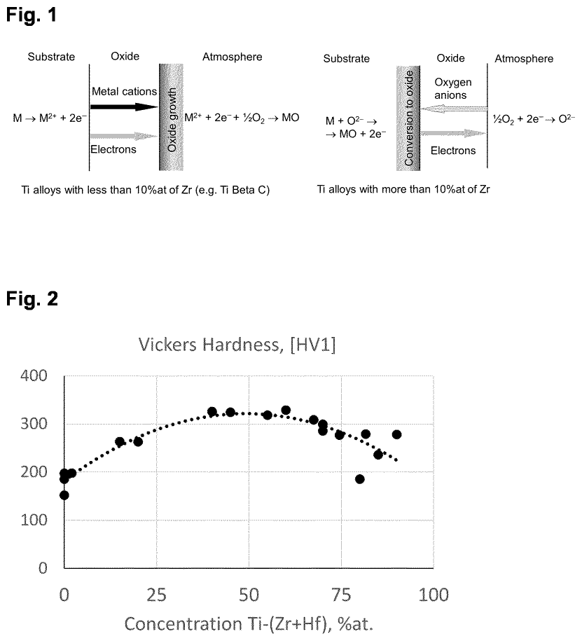

FIG. 1 schematically depicts the oxidation mechanisms of Ti—Zr alloys for different Zr contents.

For titanium alloys with little or no zirconium, it is the diffusion of Ti⁴⁺ cations at the atmosphere/oxide interface that allows the growth of a porous layer of TiO₂ during an oxidation treatment in air. This layer will not be very adherent and mechanically not very resistant.

Conversely, for Ti—Zr alloys containing a given concentration of zirconium (about >10 at. %, >17.5 wt. %) as discovered in this invention, it is the diffusion of oxygen anions through the oxide layer that allows the surface to be converted into a compact, adherent and hard oxide.

The oxidation mechanisms of titanium alloys are described in C. Leyens, “Oxidation and Protection of Titanium Alloys and Titanium Aluminides”, p. 187-230, in the book: C. Leyens and M. Peters, “Titanium and titanium alloys: fundamentals and applications”, John Wiley & Sons, 2003. However, the reference does not disclose any criteria defining the mechanism of Ti alloys oxidation depending on Zr content.

It is the finding of the inventors that the minimum content of Zr for binary and ternary alloys should be between 10 at. % and 20 at. % in order to allow formation of a dark and adherent oxide layer.

The oxidation heat treatment temperature in the process of the invention must remain below the transition temperature α→β for two reasons:
Oxygen diffusion is faster in the α phase than in the β phase, thus promoting oxide growth;
Even a partial transformation of the α phase into B phase during the thermal oxidation treatment causes a delamination of the oxide layer.

In summary, as the inventors have confirmed experimentally, for the ternary Ti—Zr—Hf alloy, oxidation heat treatment can be done for any composition with Zr concentration above 18.4 at. %, as will be described below, and at a temperature below the transition temperature α→β.

### Ti—Zr—X Alloys—Principle Tests

Tests of Ti—Zr—X alloys with X=Cr, Al, Hf, Y, Ta, Nb and Mo were preliminarily performed by the inventors to change the properties of the oxide layer (thickness, hardness, color). These tests showed that, of these metal elements, only Hafnium forms a complete solution in the Ti—Zr binary alloy at full range of concentrations of elements, without slowing down the creation of a compact and thick oxide layer (of the order of 15-20 μm at 550°/5 h) on the surface during the oxidation heat treatment under air.

Ti, Zr and Hf are transition metals belonging to group IVb of the periodic table. Hf has an atomic weight of 178.5 g/mol, compared to 91.2 g/mol for Zr and 47.9 g/mol for Ti. The density of Hf is 13.3 g/cm³, compared to 6.52 g/cm³ for Zr and 4.5 g/cm³ for Ti. Hf is therefore a heavy and dense element; an alloy can be considered an alloy of Hf and not of Ti beyond ~10 at. % of Hf. However, as mentioned above, in the present specification the terms Ti-alloy, Zr-alloy and Hf-alloy are used interchangeably.

### Ti—Zr—Hf Alloys

Different Ti—Zr—Hf alloy compositions were prepared and characterized by HV1 hardness measurements prior to oxidation. The measurements were carried with 1 kgf charge on a Knoop/Vickers hardness tester according to ISO 6507-1, 2^{nd} ed. 1997.

These measurements show (Table 1 and FIG. 2):
The hardness evolves with the Zr content and it reaches a maximum for the equiatomic composition Ti-50Zr. This result has already been noted in the literature by Kobayashi (E. Kobayashi, S. Matsumoto, H. Doi, T. Yoneyama, and H. Hamanaka, “Mechanical properties of the binary titanium-zirconium alloys and their potential for biomedical materials,” Journal of Biomedical Materials Research, vol. 29, pp. 943-950, 1995);
The hardness also evolves with the Hf content, the maximum being reached for a 25 at. % Hf content. The hardening effect of Hf was noted by Imgram for Ti-(5-40 wt. %) Hf binary alloys (A. Imgram, D. Williams, and H. Ogden, “Tensile properties of binary titanium-zirconium and titanium-hafnium alloys,” Journal of the Less Common Metals, vol. 4, pp. 217-225, 1962.)
The maximum hardness of ternary alloy Ti—Zr—Hf occurs when the cumulated atomic concentration Zr+Hf, that is the sum of atomic concentrations of Zr and Hf, is equal to the atomic concentration of Ti as shown in FIG. 2. To the best knowledge of inventors, this is the first experimental discovery of bulk hardening effect of Ti—Zr—Hf alloys by simultaneous presence of Zr and Hf.
The theoretical density in Table 1 is calculated assuming a simple proportion law. The effect of different crystal lattices was not taken into account. The formula is the following:

$$ρ = \frac{{n}_{at}^{Hf} {m}_{at}^{Hf} + {n}_{at}^{Zr} {m}_{at}^{Zr} + {n}_{at}^{Ti} {m}_{at}^{Ti}}{\frac{{n}_{at}^{Hf} {m}_{at}^{Hf}}{{ρ}^{Hf}} + \frac{{n}_{at}^{Zr} {m}_{at}^{Zr}}{{ρ}^{Zr}} + \frac{{n}_{at}^{Ti} {m}_{at}^{Ti}}{{ρ}^{Ti}}}$$

$${n}_{at} - atomic concentration of a metal in an alloy , \\ {m}_{at} - atomic mass of a metal , ρ - specific weight of a metal$$

TABLE 1
Composition of the tested alloys and their measured hardness

| | | | Theoretical |
|---|---|---|---|
| | | Standard | density |
| Alloy (atomic composition) | Hardness HV1 | deviation | [g/cm³] |
| Pure Zr* | 152 | 4.6 | — |
| Ti-30Zr* | 299.2 | 3.3 | 5.2 |
| Ti-30Zr-2.5Hf | 308.6 | 3.3 | 5.5 |
| Ti-23Zr-2.5Hf | 276.8 | 3.8 | 5.3 |
| Ti-23Zr-7Hf | 285.4 | 2.2 | 5.8 |
| Ti-10Zr-35Hf* | 318.2 | 4.8 | 8.2 |
| Ti-10Zr* | 278 | 14.8 | 4.8 |
| Ti-75Zr-10Hf | 263.2 | 17.3 | 7.0 |
| Ti-30Zr-10Hf | 328.6 | 14.0 | 6.2 |
| Ti-50Zr-10Hf | 325.8 | 10.8 | 6.6 |
| Ti-78Zr-20Hf | 197.8 | 11.0 | 7.8 |
| 90Zr-10Hf* | 197.4 | 12.6 | 7.2 |
| 80Zr-20Hf* | 185.2 | 14.1 | 7.8 |
| Ti-18.4Zr* | 279 | 19.2 | 5.0 |
| Ti-15Zr* | 236 | 16.2 | 4.9 |
| Ti-60Zr* | 325.4 | 25.9 | 5.8 |
| Ti-20Zr* | 263 | 8.2 | 5.0 |
| Ti-20Zr-35Hf | 324.2 | 12.4 | 8.3 |

*not according to the invention

### Oxidation Heat Treatment Under Air

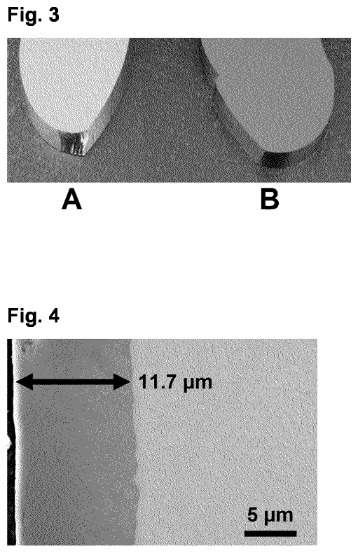

Samples of Ti—Zr—Hf alloys were then subjected to an oxidation heat treatment in air at 550° C. for 5 h. FIG. 3 is an image of the Ti-23Zr-7Hf sample before and after heat treatment and shows the change in appearance, linked to the dark color of the oxide layer formed during the heat treatment. FIG. 4 is a micrograph of a Ti-23Zr-7Hf alloy after treatment, the thickness of the layer is 11.7 μm in this case. The average thickness of the oxide layer was estimated in the SEM image on the basis of the oxide layer contrast with respect to the bulk alloy.

TABLE 2
Thicknesses of the oxide layer produced by air treatment
as a function of the alloy composition

| | Layer thickness after thermal | |
|---|---|---|
| Alloy [at. %] | oxidation at 550° C. for 5h | |
| Pure Zr* | 2.2 | μm |
| Ti-30Zr* | 18.5 | μm |
| Ti-30Zr-2.5Hf | 21.9 | μm |
| Ti-23Zr-2.5Hf | 6.1 | μm |
| Ti-23Zr-7Hf | 11.7 | μm |

| | |
|---|---|
| Ti grade 5* | -- |

*Outside the scope of the invention

Table 2 shows the layer thickness of oxide layers for the different samples: at the same processing conditions, the layer thickness varies between 6 and 22 μm for TiZrHf alloys according to the invention, compared to 18.5 μm for a TiZr alloy without Hf. The titanium content has a predominant effect on the layer thickness, decreasing it; whereas Hf, to a lesser extent, increases it.

The measurement of the hardness of the oxide layers after heat treatment by nano-indentation according to the above-cited ISO 14577-1, 1^{st} ed. 2002, gives a value higher than 12 GPa H_{IT} for both the Ti-30Zr alloy and the ternary alloy Ti-23Zr-7Hf. There is thus a priori no particular effect of Hf on the hardness of the oxide layer, the latter being systematically in the order of magnitude of 14 GPa H_{IT}.

The oxidation treatment time in air of 5 h at 550° C. allows to obtain, for Ti-23Zr-7Hf and Ti-30Zr-2.5Hf (at. %) alloys, layer thicknesses of the order of 15-20 μm.

The oxide layer formed during conversion/diffusion heat treatment is dark in appearance and shows high hardness (above 14 GPa H_{IT}). The addition of Hf brings the advantages of high layer thickness with the same processing time, already with the addition of 2.5 at. % of Hf to a Ti-30Zr alloy.

### Optimization and Effect of Chemical Composition

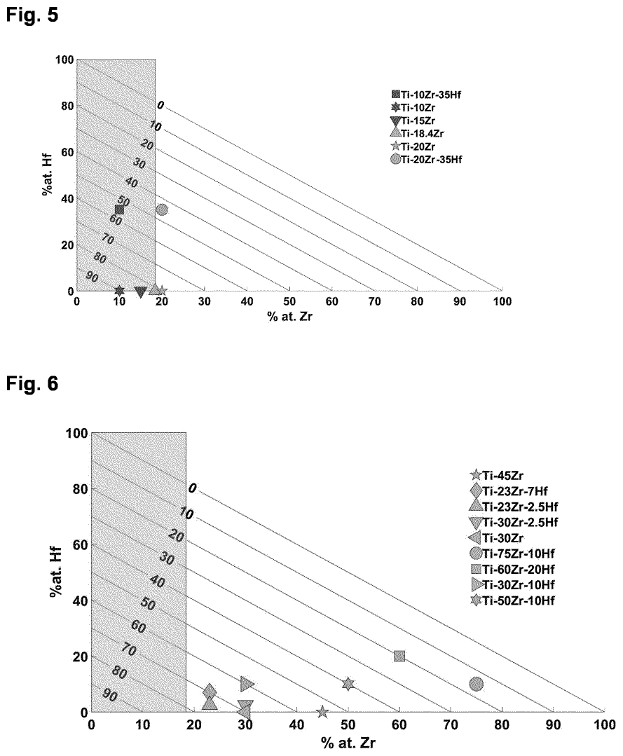

FIGS. 5-7 show the range of different chemical compositions of Ti—Zr—Hf alloys made and characterized by the inventors.

The grey area corresponds to the exclusion zone, where the Zr content is known from the dedicated experiments of the inventors described in this specification, to be too low to obtain an adherent oxide layer (Zr<18.4 at. %).

### Minimum Required Zr Content

To determine the minimum required Zr content, thermal oxidation tests were performed by the inventors at different temperatures (400, 450, 500 and 550° C.) on alloys with increasing Zr content:
a) Hafnium-free: Ti-10Zr, Ti-15Zr, Ti-18.4Zr and Ti-20Zr (outside the scope of the invention)
b) with Hafnium: Ti-10Zr-35Hf, Ti-15Zr-35Hf, Ti-18.4Zr-35Hf and Ti-20Zr-35Hf (according to the invention).

The Zr limit below which thermal oxidation in air does not produce the desired layer (FIG. 5) has been determined to be in the order of 18.4 at. %, independent of the Hf content.

### Maximum Zr Content

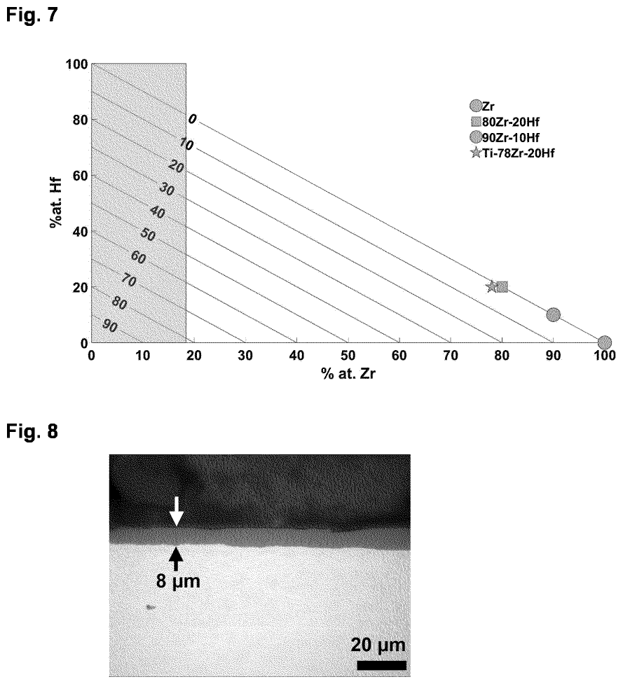

Thermal oxidation tests under air with 90Zr-10Hf (outside the scope of the invention since it is a binary alloy), 80Zr-20Hf (outside the scope of the invention since it is a binary alloy), Ti-78Zr-20Hf (within the scope of the invention) alloys and pure Zr (outside the scope of the invention since it is not an alloy) carried out by the inventors have nevertheless all demonstrated the possibility of obtaining a compact dark layer on the surface. These tests validate the high Zr-content part of the study area (FIG. 7).

Tests with Intermediate Compositions

Finally, thermal oxidation tests under air were performed by the inventors on the following chemical composites: Ti-75Zr-10Hf, Ti-30Zr-10Hf, Ti-50Zr-10Hf, Ti-78Zr-20Hf and Ti-60Zr (outside the scope of the invention since it is a binary alloy). For all these compositions, oxidation heat treatment conditions under air allowing to produce a dark layer have been identified (FIG. 6).

### Summary of the Tests

With the exception of alloys containing insufficient zirconium (less than 18.4 at. %), oxidation heat treatment conditions under air to obtain a hard dark layer could be identified for a wide spectrum of chemical compositions (Table 3):

$$0 < Ti < 81.6 \% at$$

$$18.4 < Zr < 100 \% at$$

$$0 < Hf < 40 \% at$$

TABLE 3
Summary of the oxidation heat treatment conditions under
air allowing to obtain a hard and dark oxide layer according
to the tested alloys (X: no formation of a hard dark layer,
◯: formation of a hard dark layer, -- not tested)

Oxidation temperature under air (° C.)

| Alloy | 400 | 450 | 500 | 550 |
|---|---|---|---|---|
| Pure Zr* | -- | -- | -- | ◯ |
| Ti-30Zr* | -- | -- | -- | ◯ |
| Ti-30Zr-2.5Hf | -- | -- | -- | ◯ |
| Ti-23Zr-2.5Hf | -- | -- | -- | ◯ |
| Ti-23Zr-7Hf | -- | -- | -- | ◯ |
| Ti-10Zr-35Hf* | -- | X | X | X |
| Ti-10Zr* | -- | X | X | X |
| Ti-75Zr-10Hf | ◯ | X | X | X |
| Ti-30Zr-10Hf | -- | -- | -- | ◯ |
| Ti-50Zr-10Hf | -- | -- | ◯ | X |
| Ti-78Zr-20Hf | | | | ◯ |
| 90Zr-10Hf* | -- | ◯ | -- | X |
| 80Zr-20Hf* | -- | -- | -- | ◯ |
| Ti-18.4Zr* | -- | -- | ◯ | -- |
| Ti-15Zr* | X | X | X | X |
| Ti-60Zr* | -- | ◯ | ◯ | X |
| Ti-60Zr-20Hf | ◯ | X | X | X |
| Ti-20Zr* | -- | -- | ◯ | -- |
| Ti-20Zr-35Hf | -- | -- | ◯ | |

*Outside the scope of the invention

### EXAMPLES

In the following the invention is illustrated by an Example. All samples of alloys in Table 3 above were prepared and characterized in the same manner.

### Example 1—Ti-30Zr-2.5Hf Alloy

A sample (button) of about 8 cm³ of a Ti-30Zr-2.5Hf alloy was prepared with an arc melting furnace equipped with a non-consumable tungsten electrode, under an inert atmosphere and a cold copper crucible. To prevent a macroscopic gradient of composition by insufficient mixture, the button was turned over and re-melted at least five times.

The pure elements Ti, Zr and Hf are procured in the form of slugs or chips from commercial suppliers. The pure elements are weighed and treated by ultrasonic cleaning. The metals are mixed and melted in an Arc Melting Furnace. In order to homogenize the chemical composition of the button, the button is turned over and re-melted 5 times. After cooling, the button is subsequently cut into a slice of 2 to 4 mm thickness. The flat surfaces of the slice are polished manually with P320 abrasive paper.

Subsequently to these steps of preparation of a sample of Ti-30Zr-2.5Hf alloy, the oxidation heat treatment under air is carried out using a furnace at 550° C. for 300 min. This treatment produces a dark layer of about 21.9 μm thickness with a surface hardness measured by nanoindentation as described above higher than 14 GPa H_{IT}.

After the thermal treatment, L*=44, a*=0.37 and b*=−4.8 color values were obtained following the CIE L*a*b* system as described above.

A metallographic section of a sample with the same composition as described above but oxidized for 1 minute at 600° C. followed by slow cooling to room temperature is shown in FIG. 8. This heat treatment yielded an oxide layer of 8 μm.

1. A ternary Ti—Zr—Hf alloy comprising 18.4 at. % to 80 at. % zirconium (Zr) and 2 at. % to 40 at. % hafnium (Hf), the balance being titanium (Ti), along with unavoidable impurities in an amount of up to 0.3 at. % of the final composition.

2. The ternary Ti—Zr—Hf alloy according to claim 1, wherein the amount of Hf is 2 at. % to 20 at. %.

3. The ternary Ti—Zr—Hf alloy according to claim 1, wherein the amount of Zr is 78 at. % or less.

4. The ternary Ti—Zr—Hf alloy according to claim 1, wherein the amount of is Zr 20 at. % or more.

5. The ternary Ti—Zr—Hf alloy according to claim 1, wherein the amount of Zr is 20-78 at. %.

6. The ternary Ti—Zr—Hf alloy according to claim 1, wherein the amount of Hf is 35 at. % or less.

7. The ternary Ti—Zr—Hf alloy according to claim 1, wherein the amount of Hf is 3 at. % or more.

8. The ternary Ti—Zr—Hf alloy according to claim 1, wherein the amount of Hf is 2-10 at % Hf.

9. The ternary Ti—Zr—Hf alloy according to claim 1, wherein the density of the alloy, as determined by using a Buoyancy method, is between 5 and 8 g/cm³.

10. A process for obtaining an article made of a ternary Ti—Zr—Hf alloy according to claim 1, the article having a dark oxide layer, wherein the color in CIELab color space L*a*b* is determined according to EN ISO 11664-4 “Colorimetry—Part 4: CIE 1976 L* a* b* Colour space”, ed. 2019, the process comprising the following steps:
1) manufacturing the alloy comprising amounts of Ti, Zr and Hf and accidental impurities by a usual melting process,
2) forming the alloy to the article,
3) optionally grinding, fine machining, sandblasting, brushing and/or polishing one or more surfaces of the article,
4) oxidizing one or more surfaces of the article by carrying out a heat treatment in an oxygen-containing atmosphere at a temperature of 400 to 650° C. for an appropriate time, and
5) optionally sandblasting, brushing, satin finishing or polishing the one or more oxidized surfaces.

11. The process according to claim 10, wherein the oxidizing heat treatment of the article is carried out for 1 to 420 min.

12. The process according to claim 10, wherein the oxygen-containing atmosphere is air, pure oxygen gas or oxygen containing environment.

13. The process according to claim 10,
wherein the oxidizing heat treatment is carried out by thermal heating in an oven or by plasma-electrolytic oxidation.

14. The process according to claim 10, wherein the color of the article having the dark oxide layer in CIELab color space L*a*b, determined according to EN ISO 11664-4 “Colorimetry—Part 4: CIE 1976 L* a* b* Colour space”, ed. 2019, is L*<50, |a*|<5, |b*|<5.

15. The process according to claim 10, wherein the article is a watch exterior component or a watch movement component.

16. An article made of the ternary Ti—Zr—Hf alloy according to claim 1.

17. An article made of the ternary Ti—Zr—Hf alloy according to claim 1, additionally having a dark oxide layer on one or more surfaces, wherein the color in CIELab color space L*a*b* is determined according to EN ISO 11664-4 “Colorimetry—Part 4: CIE 1976 L* a* b* Colour space”, ed. 2019.

18. The article according to claim 16, which is a watch exterior component or watch movement component.

19. The article according to claim 17, wherein the thickness of oxide layer, as determined on a metallographic cross-section of the article by Scanning Electron Microscopy or by optical microscopy, is 5 to 25 μm.

20. The article according to claim 17, wherein the hardness of the oxide layer measured by nano-indentation according to ISO 14577, 1^{st} ed. 2002, Metallic materials—Instrumented indentation test for hardness and materials parameters—Part 1: Test method, is at least 10 GPa H_{IT}.

21. A watch exterior component or a watch movement component, obtainable by the process according to claim 10.

22. The article according to claim 17, which is a watch exterior component or a watch movement component.
